(19) United States
(12) Patent Application Publication
(10) Pub. No.: US 2008/0170086 A1
(43) Pub. Date: Jul. 17, 2008

(54) FRONT END SIGNAL PROCESSING METHOD AND FRONT END SIGNAL PROCESSOR

(75) Inventors: Naohisa Hatani, Kyoto (JP); Mitsuhiko Otani, Hyogo (JP); Kouji Yamaguchi, Kyoto (JP); Shinichi Ogita, Kyoto (JP)

Correspondence Address: DICKINSON WRIGHT PLLC, 1901 L STREET NW, SUITE 800, WASHINGTON, DC, 20036, US

(73) Assignee: MATSUSHITA ELECTRIC INDUSTRIAL CO., LTD., Osaka (JP)

(21) Appl. No.: 11/971,865

(22) Filed: Jan. 9, 2008

(30) Foreign Application Priority Data
Jan. 11, 2007 (JP) 2007-003343

(51) Int. Cl. G09G 5/10

(52) U.S. Cl. 345/690

(57) ABSTRACT

(a) The luminance levels of the optical black part pixels included in the output signal of an image sensor are detected and digitized, (b) the digitized luminance levels of the optical black part pixels are averaged, (c) the number of pixels on which averaging is performed is counted, (d) a control signal is generated when the count value of the number of pixels reaches a predetermined value, (e) the black level of the output signal of the image sensor is determined from the averaged luminance level in response to the control signal, and (f) the luminance levels of the effective part pixels included in the output signal of the image sensor whose black level is determined are detected and digitized.

### BACKGROUND OF THE INVENTION

1. Field of the Invention

The present invention relates to a front end signal processing method and a front end signal processor for an image sensor.

2. Related Art

Conventionally, a structure as shown in FIG. 6 has been used as a frond end signal processor that processes a signal from an image sensor.

Referring to FIG. 6, a front end signal processor shown in Japanese Unexamined Patent Application Publication No. 2001-189892 will be described as an example of the related art.

In this conventional front end signal processor, a luminance signal from an image sensor 51 is detected and sampled by a correlated double sampler 52 (CDS) , and then, digitized by an A/D converter 53 (ADC).

Then, a reference level signal 55 is subtracted from a digital luminance signal 54 obtained from the A/D converter 53, thereby obtaining a zero-based digital luminance signal 56. The digital luminance signal 56 is converted into an analog signal by a D/A converter 57 (DAC), and the clamp level is held at a capacitor 59 by rendering a clamp switch 58 on only during the period of the OB (optical black) part of the image sensor 51 and is returned to the correlated double sampler 52 by a buffer 60.

The reference level of the digital luminance signal 56 is clamped to zero under an ideal condition where there is no DC offset in the blocks such as the correlated double sampler 52, the A/D converter 53, and the D/A converter 57 constituting the clamp feedback loop.

Further, the digital luminance signal 56 is amplified by a digital gain variable amplifier (DPGA) 61 with a gain set by a gain control signal (digital value) 62, and an OB level reference signal 63 is added thereto by an adder 64, thereby obtaining a final front end output luminance signal 65. When there is no offset under the above-mentioned ideal condition, the black level of the final front end output luminance signal 65 coincides with the OB level reference signal 63.

In the above-described FIG. 6, the correlated double sampler 52 and the A/D converter 53 constitute a luminance detecting and digitizing section 210. The D/A converter 57, the clamp switch 58, the capacitor 59, and the buffer 60 constitute a black level clamping section 220. The digital gain variable amplifier 61 and the adder 64 constitute a signal processing section 250.

While the digital luminance signal 56 is D/A-converted as it is in this example, a structure is sometimes adopted in which a signal obtained by performing averaging only on the luminance signals of the period of the OB part of the image sensor 51 previously is D/A-converted, because the clamp level is fed back only while the clamp switch 58 is on.

While black level clamping is performed by the feedback loop constituted by the correlated double sampler 52, the A/D converter 53, and the D/A converter 57 in the above-described Japanese Unexamined Patent Application Publication No. 2001-189892, there is an example in which a feed-forward loop is further formed in order to increase the accuracy of the clamp level.

Referring to FIG. 7, a front end signal processor shown in Japanese Unexamined Patent Application Publication No. 2006-072348 will be described as an example of the related art.

This front end signal processor has (a) a luminance detecting and digitizing section 210, (b) a black level clamping section 220, (c) a black level luminance detecting section 230, (d) an offset correcting section (black level correcting section) 240, and (e) a signal processing section 250, and corrects the offset of the black level of the output.

(a) The luminance detecting and digitizing section 210 is constituted by a correlated double sampler (CDS) 72 that detects the luminance information included in the output signal from an image sensor 71, and an A/D converter (ADC) 73.

(b) The black level clamping section 220 is constituted by a D/A converter 78 (DAC), a capacitor 79 for holding the clamp level, a switch 80 that is on only during a predetermined (arbitrary) charging period, and a buffer 81.

(c) The black level luminance detecting section 230 is constituted by a switch 74 that is on during the digital luminance signal period of the OB part pixels, a low-pass digital filter 75 that is fed with the output of the switch 74 being on during the digital luminance signal period of the OB part pixels, a subtracter 77 that subtracts a reference black level 76 from the output of the low-pass digital filter 75, and a low-pass digital filter 82 that is fed with the output of the switch 74 being on during the digital luminance signal period of the OB part pixels.

(d) The offset correcting section 240 is constituted by a subtracter 83 that subtracts the output of the low-pass digital filter 82 from the output of the A/D converter 73.

(e) The signal processing section 250 is constituted by a digital gain variable amplifier 85 that amplifies an output signal 88 of the subtracter 83 by being controlled by a gain control signal (digital value) 84 and an adder 87 that adds an OB reference level 86 to the output of the digital gain variable amplifier 85. A front end output luminance signal 89 is obtained from the adder 87.

In this conventional example, by subtracting the output of the low-pass digital filter 82 from the digital luminance signal output of the A/D converter 73, the offset is corrected so that the black level of the luminance signal fed to the succeeding signal processing section 250 is zero. Consequently, a stable black level luminance signal output can be obtained without affected by the DC offset of the blocks such as the correlated double sampler 72, the A/D converter 73, and the D/A converter 78 constituting the OB clamp feedback loop.

Referring now to FIG. 8, the outline of the output signal of the image sensor will be described. The image sensor 500 has an effective pixel area 501 in the center thereof, has horizontal OB pixel areas 502 and 503 on both the right and left sides of the effective pixel area 501, and has vertical OB line pixel areas 504 and 505 on both the upper and lower sides of the effective pixel area.

An arbitrary horizontal line luminance output 510 of the image sensor 500 includes a horizontal blanking part, an effective pixel part corresponding to the effective pixel area, and OB parts corresponding to horizontal OB part pixels. The illustration which is an OB part of the horizontal line luminance output 510 that is shown in enlargement is an actual sensor output signal 520. In this sensor output signal 520, the difference in voltage between a feed-through part 520a and a data part 520b corresponds to the luminance level of one OB part pixel in the waveform of the OB part.

Because of market demands for high frame rate photographing by image sensors, pixel mixture driving is performed in which a plurality of pixel signals are mixed together and outputted or pixel thinning-out driving is performed. As the number of pixels of image sensors increases, a higher thinning-out rate is required of these drivings.

However, when pixel mixture driving or pixel thinning-out driving is performed, the OB part pixels necessary for black level clamping are thinned out as well as the effective pixel area of the image sensor outputted as an image. For this reason, as the number of OB part pixels used for determining the clamp level is reduced, the luminance information is reduced, so that the accuracy sufficient for the clamp level is not obtained. Consequently, image quality degradation such as a lateral line occurs in the taken image because of the clamp level error of each horizontal line.

As described above, when the luminance information from the OB part is reduced by pixel thinning-out driving, degradation in clamp level occurs in the conventional example of FIG. 6 and the conventional example of FIG. 7. To avoid this, a measure such as optimizing the time constant of the filter in accordance with the driving mode is required. However, this increases the circuit scale.

### SUMMARY OF THE INVENTION

An object of the present invention is to provide a front end signal processing method and a front end signal processor in which a stable black level signal output can be obtained even when the number of OB part pixels is small at the time of pixel mixture driving or thinning-out driving of an image sensor.

A first front end signal processing method of the present invention is a front end signal processing method for processing an output signal of an image sensor, the method including:

(a) a first step of detecting and digitizing a luminance level of an optical black part pixel included in the output signal of the image sensor;

(b) a second step of averaging the digitized luminance level of the optical black part pixel;

(c) a third step of counting the number of pixels on which averaging is performed;

(d) a fourth step of generating a control signal when a count value of the number of pixels reaches a predetermined value;

(e) a fifth step of determining a black level of the output signal of the image sensor from the averaged luminance level in response to the control signal; and

(f) a sixth step of detecting and digitizing a luminance level of an effective part pixel included in the output signal of the image sensor whose black level is determined.

According to this method, the digitized luminance levels of the optical black part pixels are averaged, the control signal is generated when the count value of the number of pixels on which averaging is performed reaches the predetermined value, and the black level of the output signal of the image sensor is determined from the averaged luminance level in response to the control signal, so that a stable black level signal output can be obtained even when the number of OB part pixels is small at the time of pixel mixture driving or thinning-out driving of the image sensor.

It is preferable that the above-described front end signal processing method further includes (g) a seventh step of subtracting the averaged luminance level from the digitized luminance level of the effective part pixel in response to the control signal.

Moreover, in the front end signal processing method of the above-described structure, it is preferable that the control signal is generated at the fourth step at a timing when the count value of the number of pixels reaches the predetermined value.

Moreover, in the front end signal processing method of the above-described structure, the control signal may be generated at the fourth step at a timing of a next horizontal or vertical blanking period after the count value of the number of pixels reaches the predetermined value.

Now, the difference in effects between when clamping is performed immediately after the count value at the pixel number counting step reaches the predetermined value and when clamping is performed during the next horizontal or vertical blanking period after a wait for the blanking period will be described. For example, when clamping is immediately performed, although responsivity is excellent, the image of the period is influenced when the timing of the clamping is the effective pixel or OB pixel period. On the other hand, when clamping is performed during the blanking period, although there is no influence on the image, responsivity is poor. Thus, whether to perform clamping immediately or during the blanking period is necessarily determined in accordance with the situation.

Further, in the front end signal processing method of the above-described structure, the number of pixels on which averaging is performed may be different between the averaged luminance level at the seventh step and the averaged luminance level at the fifth step.

A second front end signal processing method of the present invention is a front end signal processing method for processing an output signal of an image sensor, the method including:

(a) a first step of detecting and digitizing a luminance level of an optical black part pixel included in the output signal of the image sensor;

(b) a second step of averaging the digitized luminance level of the optical black part pixel;

(c) a third step of counting the number of pixels on which averaging is performed;

(d) a fourth step of generating a control signal when a count value of the number of pixels reaches a predetermined value;

(e) a fifth step of detecting and digitizing a luminance level of an effective part pixel included in the output signal of the image sensor; and

(f) a sixth step of subtracting the averaged luminance level from the digitized luminance level of the effective part pixel in response to the control signal.

According to this method, the digitized luminance levels of the optical black part pixels are averaged, the control signal is generated when the count value of the number of pixels on which averaging is performed reaches the predetermined value, and in response to the control signal, the averaged luminance level is subtracted from the digitized luminance levels of the effective part pixels in response to the control signal, so that a stable black level signal output can be obtained even when the number of OB part pixels is small at the time of pixel mixture driving or thinning-out driving of the image sensor.

Moreover, in the front end signal processing method of the above-described structure, it is preferable that the control signal is generated at the fourth step at a timing when the count value of the number of pixels reaches the predetermined value.

Moreover, in the front end signal processing method of the above-described structure, the control signal may be generated at the fourth step at a timing of a next horizontal or vertical blanking period after the count value of the number of pixels reaches the predetermined value.

A first front end signal processor of the present invention is a front end signal processor that processes an output signal of an image sensor, the processor including:

(a) a luminance detecting and digitizing section that detects and digitizes a luminance level of an optical black part pixel included in the output signal of the image sensor, and detects and digitizes a luminance level of an effective part pixel included in the output signal of the image sensor;

(b) a pixel signal averaging section that averages the luminance level of the optical black part pixel digitized by the luminance detecting and digitizing section;

(c) a pixel number counting section that counts the number of pixels on which averaging is performed by the pixel signal averaging section;

(d) a control section that generates a control signal when a count value of the number of pixels by the pixel number counting section reaches a predetermined value; and

(e) a black level clamping section that determines a black level of the output signal of the image sensor from the luminance level averaged by the black level luminance averaging section, in response to the control signal of the control section,

wherein the black level of the output signal of the image sensor when the luminance level of the effective part pixel included in the output signal of the image sensor is detected by the luminance detecting and digitizing section is determined by the black level clamping section.

According to this structure, the digitized luminance levels of the optical black part pixels are averaged, the control signal is generated when the count value of the number of pixels on which averaging is performed reaches the predetermined value, and the black level of the output signal of the image sensor is determined from the averaged luminance level in response to the control signal, so that a stable black level signal output can be obtained even when the number of OB part pixels is small at the time of pixel mixture driving or thinning-out driving of the image sensor.

It is preferable that the above-described front end signal processor further includes a black level correcting section that subtracts the averaged luminance level from the digitized luminance level of the effective part pixel in response to the control signal from the control section.

Moreover, it is preferable that the clamp control section generates the control signal at a timing when the count value of the number of pixels by the pixel number counting section reaches the predetermined value.

Moreover, the clamp control section may generate the control signal at a timing of a next horizontal or vertical blanking period after the count value of the number of pixels by the pixel number counting section reaches the predetermined value.

Further, the number of pixels on which averaging is performed may be different between the averaged luminance level in the black level correcting section and the averaged luminance level in the black level clamping section.

A second front end signal processor of the present invention is a front end signal processor that processes an output signal of an image sensor, the processor including:

(a) a luminance detecting and digitizing section that detects and digitizes a luminance level of an optical black part pixel included in the output signal of the image sensor, and detects and digitizes a luminance level of an effective part pixel included in the output signal of the image sensor;

(b) a pixel signal averaging section that averages the luminance level of the optical black part pixel digitized by the luminance detecting and digitizing section;

(c) a pixel number counting section that counts the number of pixels on which averaging is performed by the pixel signal averaging section;

(d) a control section that generates a control signal when a count value of the number of pixels by the pixel number counting section reaches a predetermined value; and

(e) a black level correcting section that subtracts the averaged luminance level from the digitized luminance level of the effective part pixel in response to the control signal from the control section.

According to this method, the digitized luminance levels of the optical black part pixels are averaged, the control signal is generated when the count value of the number of pixels on which averaging is performed reaches the predetermined value, and the averaged luminance level is subtracted from the luminance levels of the digitized effective part pixels in response to the control signal, so that a stable black level signal output can be obtained even when the number of OB part pixels is small at the time of pixel mixture driving or thinning-out driving of the image sensor.

In the above-described front end signal processor, it is preferable that the clamp control section generates the control signal at a timing when the count value of the number of pixels by the pixel number counting section reaches the predetermined value.

Moreover, the clamp control section may generate the control signal at a timing of a next horizontal or vertical blanking period after the count value of the number of pixels by the pixel number counting section reaches the predetermined value.

According to the present invention, a stable black level signal output can be obtained even when the number of OB part pixels is small at the time of pixel mixture driving or thinning-out driving of the image sensor. In realizing this, the increase in circuit scale can be suppressed.

### BRIEF DESCRIPTION OF THE DRAWINGS

FIG. 1 is a block diagram showing the structure of a first embodiment of the present invention.

FIG. 2 is a block diagram showing the structure of a second embodiment of the present invention.

FIG. 3 is a block diagram showing the structure of a third embodiment of the present invention.

FIG. 4 is a block diagram showing the structure of a fourth embodiment of the present invention.

FIG. 5 is a block diagram showing the structure of a fifth embodiment of the present invention.

FIG. 6 is a block diagram showing the structure of the first conventional example.

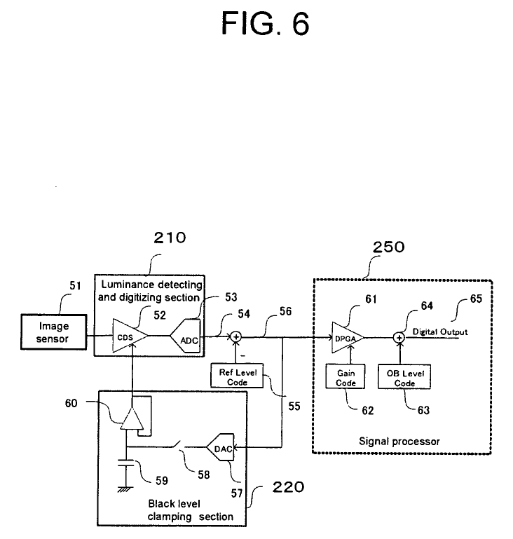

FIG. 7 is a block diagram showing the structure of the second conventional example.

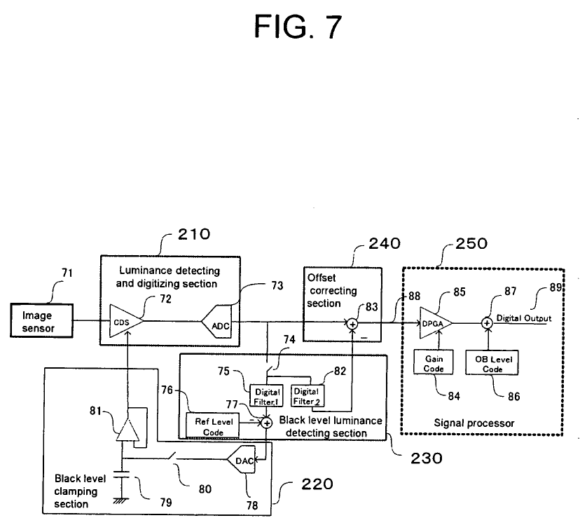

FIG. 8 is a schematic view showing the outline of the output signal of the image sensor.

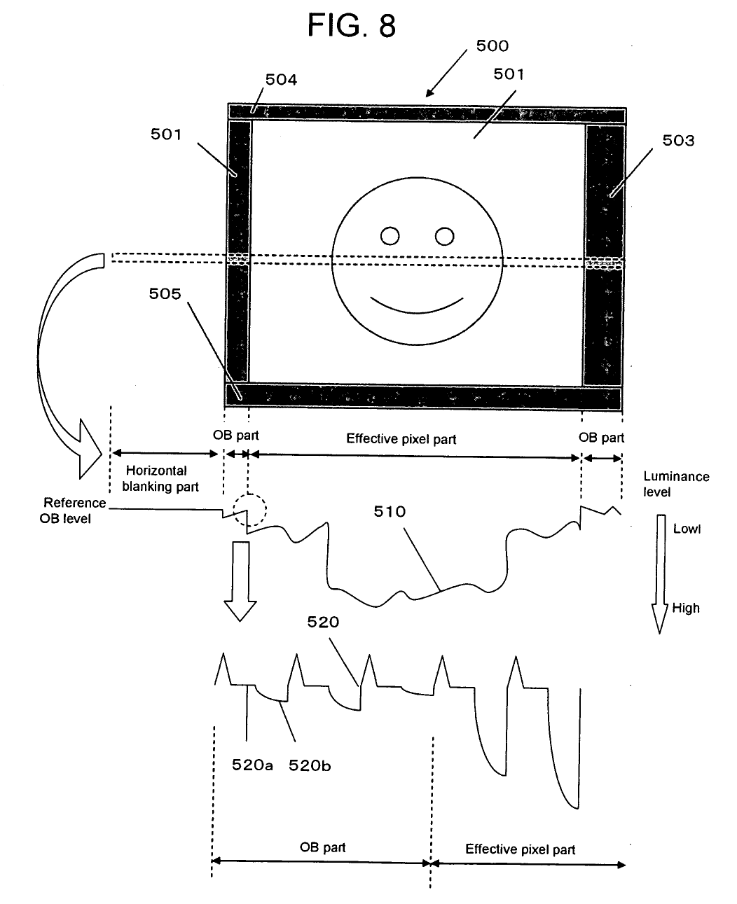

FIG. 9 is a flowchart showing a front end signal processing method for the front end signal processor of FIG. 1.

FIG. 10 is a flowchart showing a front end signal processing method for the front end signal processor of FIG. 2.

FIG. 11 is a flowchart showing a front end signal processing method for the front end signal processor of FIG. 5.

### DESCRIPTION OF PREFERRED EMBODIMENTS

Hereinafter, embodiments of the present invention will be described with reference to the drawings.

### First Embodiment

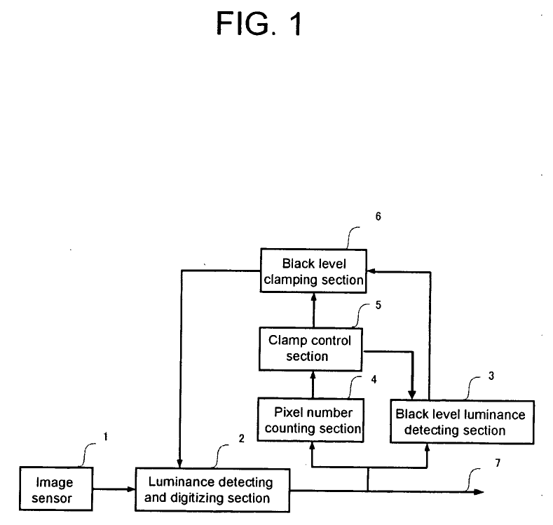

FIG. 1 is a block diagram showing the basic structure of a front end signal processor according to a first embodiment of the present invention. This front end signal processor has (a) a luminance detecting and digitizing section 2, (b) a black level luminance detecting section 3 that detects the black level of the luminance signal, (c) a pixel number counting section 4, (d) a clamp control section 5, and (e) a black level clamping section 6. Reference numeral 7 represents an output signal of the luminance detecting and digitizing section 2.

(a) The luminance detecting and digitizing section 2 detects and digitizes the luminance levels of the optical black part pixels included in the output signal of an image sensor 1, and detects and digitizes the luminance levels of the effective part pixels included in the output signal of the image sensor 1.

(b) The black level luminance detecting section 3 averages the luminance levels of the optical black part pixels digitized by the luminance detecting and digitizing section 2.

(c) The pixel number counting section 4 counts the number of pixels on which averaging is performed by the black level luminance detecting section 3.

(d) The clamp control section 5 generates a clamp control signal when the count value of the number of pixels by the pixel number counting section 4 reaches a predetermined value.

(e) The black level clamping section 6 determines the black level of the output signal of the image sensor 1 from the averaged luminance level obtained by the black level detecting section 3, in response to the clamp control signal of the clamp control section 5.

The black level of the output signal of the image sensor 1 when the luminance levels of the effective part pixels included in the output signal of the image sensor 1 are detected by the luminance detecting and digitizing section 2 is determined by the black level clamping section 6.

As the image sensor 1, a CCD image sensor, a CMOS image sensor, or any other arbitrary image sensor may be used.

The signals from the image sensor 1 are broadly divided into luminance signals from the effective pixel part of the light receiving section in the center of the sensor and luminance signals from the light intercepted section (OB part) disposed around the light receiving section. The luminance signal detecting and digitizing section 2 detects the luminances of the effective pixel signals and the OB part pixel signals, and converts them into digital luminance signals.

The black level luminance detecting section 3 stores the luminance information of the OB part pixels, and outputs the luminance information to the black level clamping section 6. The luminance information outputted here can also be calculated by the stored average value of the OB part pixels or by an arbitrary calculation method other than that.

The pixel number counting section 4 integrates (counts) the number of OB pixels stored in the black level luminance detecting section 3, and outputs the value to the clamp control section 5.

The clamp control section 5 outputs the clamp control signal for starting the clamping operation, to the black level clamping section 6 when the integrated number of pixels reaches a predetermined number.

The black level clamping section 6 performs feedback to the luminance signal detecting and digitizing section 2 so that the difference between the OB part luminance information from the black level luminance detecting section 3 and the reference black level is zero, by the above-mentioned clamp control signal for starting the clamping operation.

The clamp control signal may be outputted either immediately after the number of pixels reaches a given number or during the next horizontal or vertical blanking period after the number of pixels reaches the given number.

When the number of OB part pixels of one horizontal line is less than the predetermined number, the clamp control signal is not inputted on the horizontal line, the integrated number of pixels and luminance information of the OB part are carried forward to the next horizontal line, and the number of pixels and luminance information of the horizontal line are integrated. After integration is repeated until the number of pixels reaches the predetermined number in this manner, the clamp control signal for starting the clamping operation is outputted.

While when the number of OB part pixels of one horizontal line is equal to or more than the predetermined number, integration may be ended at that point of time, the clamping operation may be performed after all the pixels of the OB part of the horizontal line are integrated, to further improve the accuracy of the OB part luminance information.

As described above, in the front end signal processor according to the embodiment of the present invention, since the clamping operation is performed only when the number of OB part pixels reaches a given number even in a case where the number of OB part pixels is small such as at the time of pixel mixture driving or pixel thinning-out driving of the image sensor, clamp accuracy degradation due to an insufficient integrated number of pixels does not occur, and image quality degradation due to the occurrence of a lateral line arising from clamp accuracy degradation can be prevented.

In addition, since the clamping operation can be performed every OB part when there are a sufficient number of horizontal OB part pixels and when there are a sufficient number of OB part pixels on the vertical OB line, pulling at the time of clamp pulling from high luminance or at the time of power-on can be performed as previously done, and a defect that the pulling time is long is absent.

A front end signal processing method carried out by the above-described front end signal processor will be described.

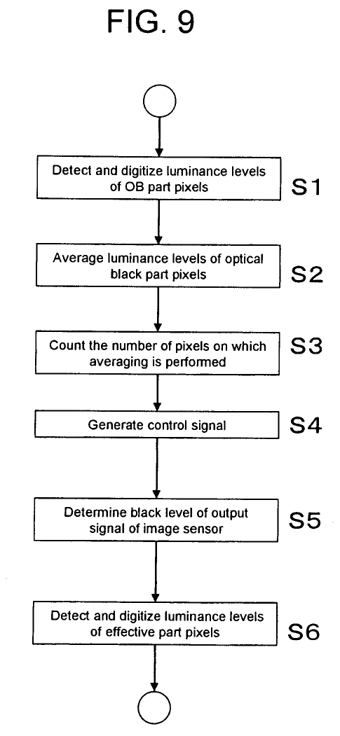

This front end signal processing method is a front end signal processing method for processing the output signal of an image sensor, and includes, as shown FIG. 9:

(a) a first step S1 of detecting and digitizing the luminance levels of the optical black part pixels included in the output signal of the image sensor;

(b) a second step S2 of averaging the digitized luminance levels of the optical black part pixels;

(c) a third step S3 of counting the number of pixels on which averaging is performed;

(d) a fourth step S4 of generating a control signal when the count value of the number of pixels reaches a predetermined value;

(e) a fifth step S5 of determining the black level of the output signal of the image sensor from the averaged luminance level in response to the control signal; and

(f) a sixth step S6 of detecting and digitizing the luminance levels of the effective part pixels included in the output signal of the image sensor whose black level is determined.

In the above-described front end signal processing method, the control signal is generated at the fourth step S4 at the timing when the count value of the number of pixels reaches the predetermined value, or the control signal is generated at the fourth step S4 at the timing of the next horizontal or vertical blanking period after the count value of the number of pixels reaches the predetermined value.

### Second Embodiment

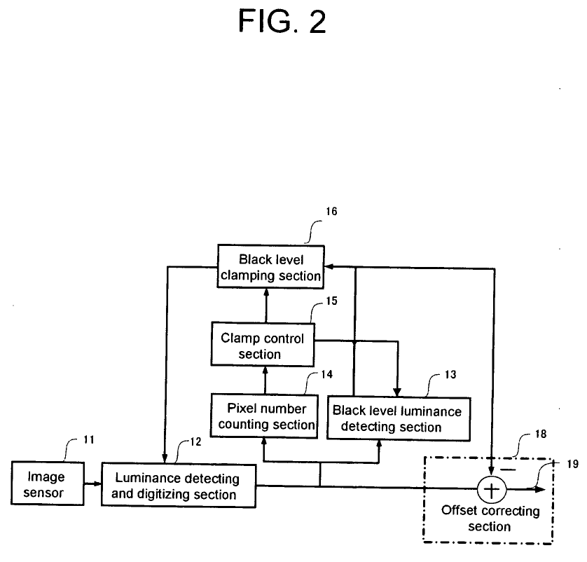

FIG. 2 is a block diagram showing the basic structure of a front end signal processor according to a second embodiment of the present invention. This front end signal processor has (a) a luminance detecting and digitizing section 12, (b) a black level luminance detecting section 13 that detects the black level of the luminance signal, (c) a pixel number counting section 14, (d) a clamp control section 15, (e) a black level clamping section 16, and (f) an offset correcting section 18. Reference numeral 19 represents an output signal of the offset correcting section 18.

In the front end signal processor of FIG. 2, (a) the luminance detecting and digitizing section 12, (b) the black level luminance detecting section 13 that detects the black level of the luminance signal, (c) the pixel number counting section 14, (d) the clamp control section 15, and (e) the black level clamping section 16 are similar to those of the front end signal processor of FIG. 1. This embodiment is different from the first embodiment in that (f) the offset correcting section 18 is further provided.

(f) The offset correcting section 18 subtracts the averaged luminance level from the digitized luminance levels of the effective pixels in response to the control signal from the clamp control section 15, thereby correcting the offset.

In the feedback loop constituted by the luminance signal detecting and digitizing section 12, the black level luminance detecting section 13, and the black level clamping section 16, there are cases where an offset from the reference black level is caused due to the offsets of the analog blocks constituting the sections, and the offset correcting section 17 corrects the offset.

The offset value is calculated from the difference between the luminance information and the reference black level by the black level luminance detecting section 13. This offset value is calculated as the average value of the luminance level of the OB part, and is outputted to the offset correcting section 18 after the integrated number of pixels by the pixel counting section 14 reaches a predetermined value. While the luminance information can be calculated by taking the average value of the luminances of the OB part pixels by the black level detecting section 13, in addition thereto, a value calculated by an arbitrary low-pass digital filter may be used.

The offset correcting section 18 digitally subtracts the averaged luminance level (corresponding to the offset) detected by the black level luminance detecting section 13, from the digital luminance signal outputted from the luminance signal detecting and digitizing section 12. Thereby, the offset-corrected digital luminance signal is a signal whose black level is clamped to zero.

The number of OB pixels used for offset correction is not necessarily the same as the number of OB pixels used for controlling the black level clamping section 16. Clamp control and offset correction can each be performed at an independent timing according to the characteristics of the preceding feedback loop for black level clamping and the succeeding feed-forward loop for offset correction.

As described above, the present invention is also applicable to a front end signal processor in which the offset caused in the feedback loop for black level clamping is corrected to obtain a luminance signal output having a stabilized black level.

A front end signal processing method carried out by the above-described front end signal processor will be described.

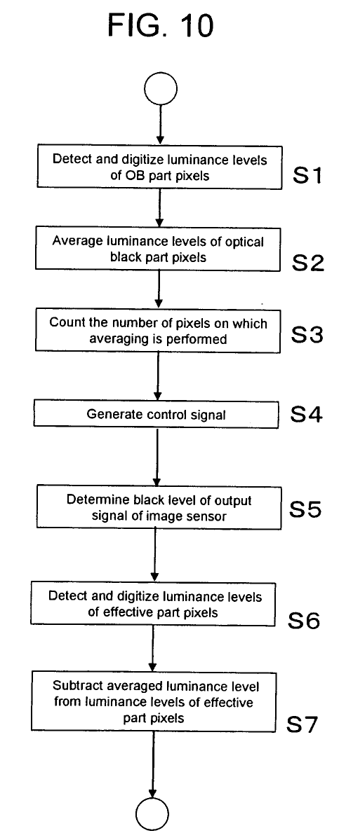

This front end signal processing method is a front end signal processing method for processing the output signal of an image sensor, and as shown in FIG. 10, is a processing in which (g) a seventh step S7 of subtracting the averaged luminance level from the digitized luminance levels of the effective part pixels in response to the control signal is added to the last of the flow chart of FIG. 9.

In the above-described front end signal processing method, the number of pixels on which averaging is performed may be different between the averaged luminance level at the step S7 and the averaged luminance level at the step S5.

### Third Embodiment

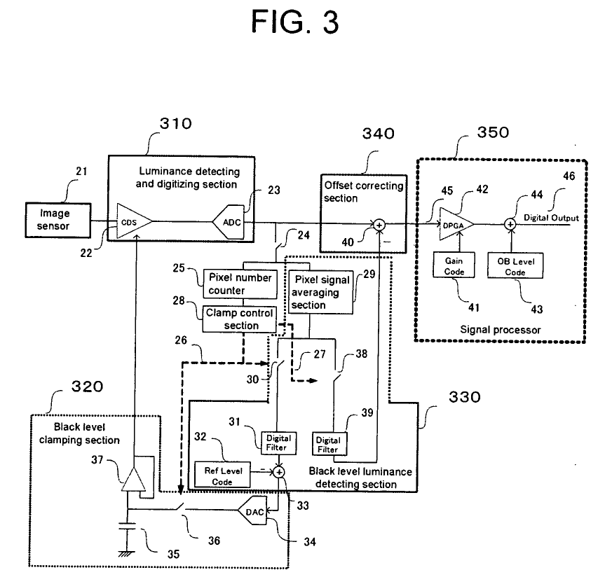

FIG. 3 is a block diagram showing a front end signal processor which is the structure of FIG. 2 that is made more concrete. This front end signal processor has (a) a luminance detecting and digitizing section 310, (b) a pixel number counter 25, (c) a clamp control section 28, (d) a black level clamping section 320, (e) a black level luminance detecting section 330, (f) an offset correcting section 340, and (g) a signal processing section 350, and corrects the black level of the output to the reference black level with stability.

(a) The luminance detecting and digitizing section 310 is constituted by a correlated double sampler (CDS) 22 that detects the luminance information included in the output signal from an image sensor 21 and an A/D converter (ADC) 23.

(b) The pixel number counter 25 integrates (counts) the number of OB part pixels based on the digital luminance signal of the OB part pixels inputted through a switch 24 that is on during the digital luminance signal period of the OB part pixels.

(c) The clamp control circuit 28 generates a clamp start signal 26 and an offset correction start signal 27 when the count value of the OB part pixels, that is, the integrated number of pixels reaches a predetermined value.

(d) The black level clamping section 320 is constituted by a D/A converter (DAC) 34, a capacitor 35 for holding the clamp level, a switch 36 that is on only during a predetermined charging period by the clamp start signal 26, and a buffer 37.

(e) The black level luminance detecting section 330 is constituted by a pixel signal averaging section 29 that averages the OB part pixel signals of the period during which the switch 24 is on, a switch 30 that is turned on by the clamp start signal, a low-pass digital filter 31 that is fed with the output of the OB part pixel averaging section 29 through a switch 38, a subtracter 33 that subtracts a reference black level 32 from the output of the low-pass digital filter 31, the switch 38 that is turned on by the offset correction start signal 27, and a low-pass digital filter 39 that is fed with the output of the OB part pixel averaging section 29 through the switch 38.

(f) The offset correcting section 340 is constituted by a subtracter 40 that subtracts the output of the low-pass digital filter 39 from the output of the A/D converter 23.

(g) The signal processor 350 is constituted by a digital gain variable amplifier 42 that amplifies an output signal 45 of the subtracter 40 by being controlled by a gain control signal 41 and an adder 44 that adds an OB reference level 43. A front end output luminance signal 46 is obtained from the adder 44.

The clamp start signal 26 and the offset correction start signal 27 are not necessarily the same, and may be each generated at a point of time when a given number of OB pixels are accumulated. Since the timing can be independently set as mentioned above, the optimum number of pixels can be selected according to the characteristic of each of the clamp loop and the offset correction loop. The clamp start signal 26 and the offset correction start signal 27 are on (at the time of update) during the normal blanking period, and the values thereof are held. For this reason, the clamp start signal 26 and the offset correction start signal 27 may be turned off at any time.

Moreover, since the clamping operation is not performed when the number of pixels of the OB period is insufficient and the clamping operation is performed after a predetermined number of pixels are accumulated, no degradation in clamp accuracy occurs.

As described above, according to the embodiment of the present invention, a front end signal processor is provided in which a stable black level luminance signal output is obtained even when the number of OB part pixels is small.

While both the feedback loop and the feed-forward loop use the result of pixel number counting in the structure of FIG. 3, a structure may be adopted in which pixel number counting is applied to only one of them.

### Fourth Embodiment

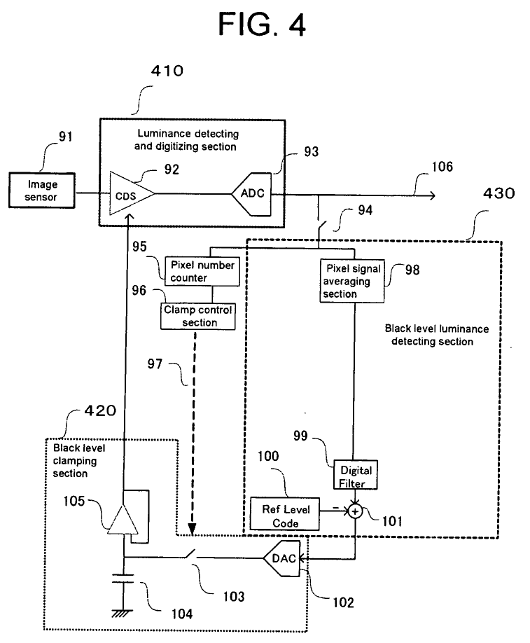

FIG. 4 shows a front end signal processor which is the structure of FIG. 1 that is made more concrete. The structure thereof is similar to a structure in which the structure of the offset correcting section 340 is omitted from the structure of FIG. 3 and accordingly, the switch 38 and the low-pass digital filter 39 are omitted from the black level luminance detecting section 330. In FIG. 4, reference numeral 91 represents an image sensor, reference numeral 92 represents a correlated double sampler (CDS), reference numeral 93 represents an A/D converter (ADC), reference numeral 94 represents a switch, reference numeral 95 represents a pixel number counter, reference numeral 96 represents a clamp control section, reference numeral 97 represents a clamp start signal, reference numeral 98 represents a pixel signal averaging section, reference numeral 99 represents a low-pass digital filter, reference numeral 100 represents a reference black level, reference numeral 101 represents a subtracter, reference numeral 102 represents a D/A converter, reference numeral 103 represents a switch, reference numeral 104 represents a capacitor, reference numeral 105 represents a buffer, and reference numeral 106 represents a front end output luminance signal. Reference numeral 410 represents a luminance detecting and digitizing section, reference numeral 420 represents a black level clamping section, and reference numeral 430 represents a black level luminance detecting section.

The effects of this embodiment are similar to those of the first embodiment.

### Fifth Embodiment

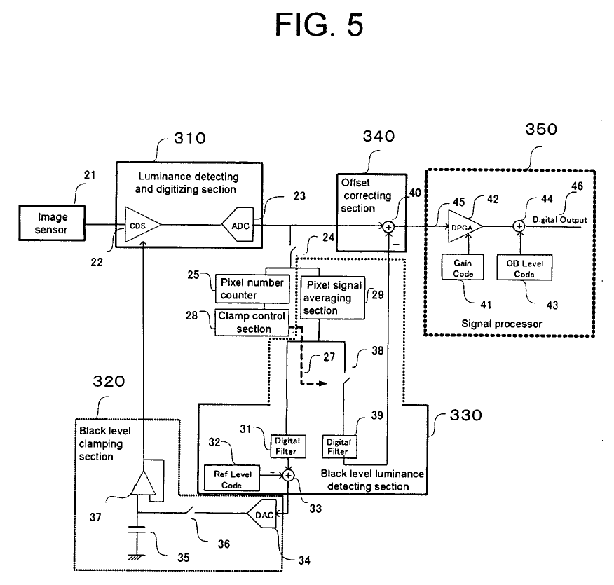

FIG. 5 shows an embodiment in which averaging and pixel number counting are performed on the feed-forward loop and are not applied to the feedback loop. FIG. 5 of this embodiment is a structure in which the switch 30 is omitted from FIG. 3 and the switch 36 is not controlled by the clamp control signal 26 but turned on every horizontal line or in the OB pixel part of each field.

The effects of this embodiment are similar to those of the first embodiment.

A front end signal processing method carried out by the above-described front end signal processor will be described.

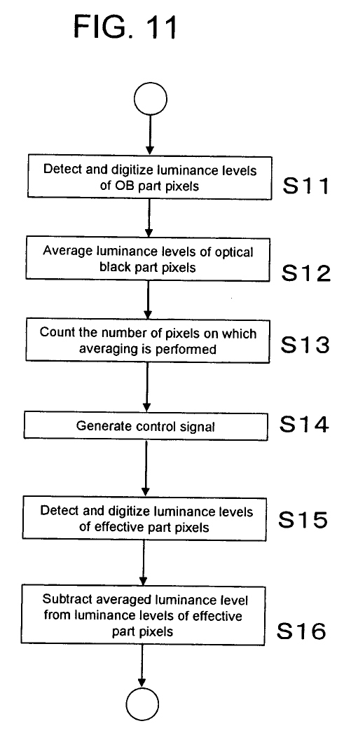

This front end signal processing method is a front end signal processing method for processing the output signal of an image sensor, and includes, as shown FIG. 11:

(a) a first step S11 of detecting and digitizing the luminance levels of the optical black part pixels included in the output signal of the image sensor;

(b) a second step S12 of averaging the digitized luminance levels of the optical black part pixels;

(c) a third step S13 of counting the number of pixels on which averaging is performed;

(d) a fourth step S14 of generating a control signal when the count value of the number of pixels reaches a predetermined value;

(e) a fifth step S15 of detecting and digitizing the luminance levels of the effective part pixels included in the output signal of the image sensor; and

(f) a sixth step S16 of subtracting the averaged luminance level from the digitized luminance levels of the effective pixels in response to the control signal.

In the above-described front end signal processing method, the control signal is generated at the fourth step S4 at the timing when the count value of the number of pixels reaches the predetermined value, or the control signal is generated at the fourth step S4 at the timing of the next horizontal or vertical blanking period after the count value of the number of pixels reaches the predetermined value.

### INDUSTRIAL APPLICABILITY

As described above, the present invention is useful for a front end signal processing method or signal processor for an image sensor, and a signal processing system and a semiconductor integrated device system having these.

What is claimed is:

1. A front end signal processing method for processing an output signal of an image sensor, the method comprising:
(a) a first step of detecting and digitizing a luminance level of an optical black part pixel included in the output signal of the image sensor;
(b) a second step of averaging the digitized luminance level of the optical black part pixel;
(c) a third step of counting the number of pixels on which averaging is performed;
(d) a fourth step of generating a control signal when a count value of the number of pixels reaches a predetermined value;
(e) a fifth step of determining a black level of the output signal of the image sensor from the averaged luminance level in response to the control signal; and
(f) a sixth step of detecting and digitizing a luminance level of an effective part pixel included in the output signal of the image sensor whose black level is determined.

2. The front end signal processing method according to claim 1, further comprising
(g) a seventh step of subtracting the averaged luminance level from the digitized luminance level of the effective part pixel in response to the control signal.

3. The front end signal processing method according to claim 1, wherein the control signal is generated at the fourth step at a timing when the count value of the number of pixels reaches the predetermined value.

4. The front end signal processing method according to claim 1, wherein the control signal is generated at the fourth step at a timing of a next horizontal or vertical blanking period after the count value of the number of pixels reaches the predetermined value.

5. The front end signal processing method according to claim 2, wherein the number of pixels on which averaging is performed is different between the averaged luminance level at the seventh step and the averaged luminance level at the fifth step.

6. A front end signal processing method for processing an output signal of an image sensor, the method comprising:
(a) a first step of detecting and digitizing a luminance level of an optical black part pixel included in the output signal of the image sensor;
(b) a second step of averaging the digitized luminance level of the optical black part pixel;
(c) a third step of counting the number of pixels on which averaging is performed;
(d) a fourth step of generating a control signal when a count value of the number of pixels reaches a predetermined value;
(e) a fifth step of detecting and digitizing a luminance level of an effective part pixel included in the output signal of the image sensor; and
(f) a sixth step of subtracting the averaged luminance level from the digitized luminance level of the effective part pixel in response to the control signal.

7. The front end signal processing method according to claim 6, wherein the control signal is generated at the fourth step at a timing when the count value of the number of pixels reaches the predetermined value.

8. The front end signal processing method according to claim 6, wherein the control signal is generated at the fourth step at a timing of a next horizontal or vertical blanking period after the count value of the number of pixels reaches the predetermined value.

9. A front end signal processor that processes an output signal of an image sensor, the processor comprising:
(a) a luminance detecting and digitizing section that detects and digitizes a luminance level of an optical black part pixel included in the output signal of the image sensor, and detects and digitizes a luminance level of an effective part pixel included in the output signal of the image sensor;
(b) a pixel signal averaging section that averages the luminance level of the optical black part pixel digitized by the luminance detecting and digitizing section;
(c) a pixel number counting section that counts the number of pixels on which averaging is performed by the pixel signal averaging section;
(d) a control section that generates a control signal when a count value of the number of pixels by the pixel number counting section reaches a predetermined value; and
(e) a black level clamping section that determines a black level of the output signal of the image sensor from the luminance level averaged by the pixel signal averaging section, in response to the control signal of the control section,
wherein the black level of the output signal of the image sensor when the luminance level of the effective part pixel included in the output signal of the image sensor is detected by the luminance detecting and digitizing section is determined by the black level clamping section.

10. The front end signal processor according to claim 9, further comprising a black level correcting section that subtracts the averaged luminance level from the digitized luminance level of the effective part pixel in response to the control signal from the control section.

11. The front end signal processor according to claim 9, wherein the clamp control section generates the control signal at a timing when the count value of the number of pixels by the pixel number counting section reaches the predetermined value.

12. The front end signal processor according to claim 9, wherein the clamp control section generates the control signal at a timing of a next horizontal or vertical blanking period after the count value of the number of pixels by the pixel number counting section reaches the predetermined value.

13. The front end signal processor according to claim 10, wherein the number of pixels on which averaging is performed is different between the averaged luminance level in the black level correcting section and the averaged luminance level in the black level clamping section.

14. A front end signal processor that processes an output signal of an image sensor, the processor comprising:
(a) a luminance detecting and digitizing section that generates a digital luminance signal detecting and digitizing a luminance level of an optical black part pixel included in the output signal of the image sensor and detecting and digitizing a luminance level of an effective part pixel included in the output signal of the image sensor;
(b) a pixel signal averaging section that averages the luminance level of the optical black part pixel digitized by the luminance detecting and digitizing section;
(c) a pixel number counting section that counts the number of pixels on which averaging is performed by the pixel signal averaging section;
(d) a control section that generates a control signal when a count value of the number of pixels by the pixel number counting section reaches a predetermined value; and
(e) a black level correcting section that subtracts the averaged luminance level from the digitized luminance level of the effective part pixel in response to the control signal from the control section.

15. The front end signal processor according to claim 9, wherein the clamp control section generates the control signal at a timing when the count value of the number of pixels by the pixel number counting section reaches the predetermined value.

16. The front end signal processor according to claim 9, wherein the clamp control section generates the control signal at a timing of a next horizontal or vertical blanking period after the count value of the number of pixels by the pixel number counting section reaches the predetermined value.
